(19) United States
(12) Patent Application Publication
(10) Pub. No.: US 2018/0163104 A1
(43) Pub. Date: Jun. 14, 2018

(54) BLOCKED POLYURETHANE TOUGHENERS FOR EPOXY ADHESIVES

(71) Applicant: Dow Global Technologies LLC, Midland, MI (US)

(72) Inventors: Andreas Lutz, Galgenen (CH); Daniel Schneider, Waedenswil (CH); Bindu Krishnan, Lake Jackson, TX (US); Tyler Auvil, Lake Orion, MI (US)

(73) Assignee: Dow Global Technologies LLC, Midland, MI (US)

(21) Appl. No.: 15/574,601

(22) PCT Filed: May 31, 2016
(86) PCT No.: PCT/US16/34988

§ 371 Date: Nov. 16, 2017

Related U.S. Application Data
(60) Provisional application No. 62/169,742, filed on Jun. 2, 2015.

(51) Int. Cl. C09J 175/08; C09J 175/14; C09J 163/00; C08G 18/10; C08G 18/24; C08G 18/32; C08G 18/48; C08G 18/62; C08G 18/66; C08G 18/73; C08G 18/75

(52) U.S. Cl. CPC C09J 175/08; C09J 175/14; C09J 163/00; C08G 18/10; C08G 18/246; C08G 18/755; C08G 18/3215; C08G 18/4854; C08G 18/6204; C08G 18/6677; C08G 18/73; C08G 18/3206

(57) ABSTRACT

The invention is directed to a toughener for epoxy adhesives, the toughener being a reaction product of a bisphenolic blocked PU toughener with a diglycidyl ether-bisphenol product such liquid DGEBA. The invention includes adhesives comprising the inventive tougheners, methods of using the tougheners and adhesives comprising them, as well as cured inventive adhesives and products comprising them.

### FIELD OF THE INVENTION

The invention relates to epoxy-blocked polyurethane tougheners. Such tougheners are useful in epoxy adhesive formulations, such as one-part structural adhesives that can be used in the automotive industry.

### INTRODUCTION

Polyphenolic blocked polyurethane tougheners, such as described in U.S. Pat. Nos. 5,278,257 and 7,557,168, are used as very efficient toughening polymers to primarily toughen one-part structural epoxy adhesives. Such adhesives are useful in several applications, such as in an automotive body shop. These tougheners provide high dynamic impact peel strength values and provide good adhesive bulk properties (e.g., elastic moduli or elongation at break).

Typically, bisphenol A or modifications like o,o′-diallyl-bisphenol A are used to block (or cap) isocyanate terminated pre-polymers. The bisphenol is used in excess to guarantee a full conversion of the isocyanate functional groups into urethane groups. The remaining unreacted bisphenol content is generally about 3 to 10% in the final polymer (toughener composition). This excess of aromatic hydroxy groups (e.g., bisphenol A), as well as the remaining OH functional group of the toughening polymer, limit the shelf life stability of the final adhesive formulation.

The shelf life stability is commonly followed by testing viscosity as a function of time and storage temperature. Other capping groups, such as mono-phenols or secondary amines (e.g., as described in U.S. Pat. Nos. 8,404,787 and 7,625,977) offer good shelf life stability because of the mono-functionality of the blocking agents; in contrast to the bi-functionality of bisphenolic blocking compounds. Mono-functional blocking groups offer inferior (lower) mechanical adhesive properties like lap shear strength or elastic modulus, because after de-blocking, the mono-functionality of the blocking agent acts as a chain terminator of the epoxy resin polymerization.

As understood by those of ordinary skill in the art, these isocyanate blocked tougheners work well in adhesive formulations because the blocking group de-blocks under heat while the adhesive is curing and incorporates into the epoxy matrix to provide a better interface between the toughener phase and the epoxy phase.

However, bisphenolic or poly-phenolic blocking agents act as chain extenders or as cross-linkers due to their at least bi-functionality or poly-functionality. Cured adhesive properties using bis- or polyphenolic blocked toughener polymers exhibit higher elastic moduli, and as a result, higher mechanical properties like higher lap shear strength values.

Toughening polymers are described in EP 1 498 441 A1 and EP 1 741 734 A1, which incorporate preferably bis-functional phenols like bisphenol M into the polymer chain, and which block the isocyanate pre-polymer by special hydroxyl-glycidyl compounds. EP 1 741 734 A1 describes the additional use of solid epoxy resin in the adhesive formulation to improve the dynamic impact strength performance, which is a test method to judge the crash performance of a joint. Such formulations show a rather high adhesive viscosity.

EP 1 498 441 A1 describes toughening polymers for use in epoxy adhesive formulations which use bisphenolic compounds in the polymer chain and block the isocyanate functional groups by using special monohydroxy-glycidyl components.

EP 1 900 774 A1 describes the use of epoxy-PU resins (urethane modified epoxies) in combination with caprolactom-blocked PU polymers for use in epoxy based adhesive formulations. The isocyanate pre-polymer is directly reacted with an epoxy resin.

There remains a need for tougheners for epoxy adhesives, the adhesives having good shelf life stability, good mechanical adhesive properties, or both. There remains a need for toughened epoxy adhesives having good shelf life stability, good mechanical properties, or both.

### SUMMARY OF THE INVENTION

It has been found that these and other benefits are provided by a toughener that is a reaction product of a bisphenolic blocked PU toughener with a diglycidyl ether-bisphenol product such as liquid DGEBA. The inventive compositions include tougheners that comprise an epoxy terminated polyurethane coupled via a polyphenolic blocking agent.

The present invention provides a reaction product of a first reaction product of an isocyanate terminated prepolymer, and a capping compound having a di-functional aromatic moiety, wherein the first reaction product is terminated with the capping compound; and a diglycidyl bisphenol epoxy resin; wherein the reaction product is suitable for use as a toughener in an epoxy adhesive composition.

The present invention also provides a reaction product of an isocyanate terminated prepolymer; a polyphenol or a dihydroxy functional benzene; and a diglycidyl bisphenol epoxy resin; wherein the reaction product is suitable for use as a toughener in an epoxy adhesive composition.

The present invention also provides a composition suitable for use as a toughener in an epoxy adhesive composition, the composition comprising an epoxy terminated polyurethane coupled via a polyphenolic or other aromatic dihydroxy compound.

### BRIEF DESCRIPTION OF THE DRAWINGS

FIG. 1 shows evolution of EEW before and after catalyst quenching.

FIG. 2 is a set of ¹H NMR spectra showing consumption of phenolic —OH functionality.

### DETAILED DESCRIPTION OF THE INVENTION

It has been found that reacting a bisphenolic blocked PU toughener with such a DGEBA epoxy resin blocks the remaining —OH functional group of the PU polymer and blocks the residual (excess) bisphenol in the polymer. Without being bound by theory, it is believed that the bisphenolic functions as both the blocking agent for the isocyanate as well as a coupling agent between the polyurethane and the epoxy. It is further believed that one or both of these effects contributes to increased adhesive shelf stability and/or increased mechanical properties of the cured adhesive. Adhesive formulations comprising such epoxy-terminated tougheners offer significantly better shelf life stability compared to adhesive formulations comprising bisphenolic blocked tougheners. The reactivity of the toughener with the epoxy matrix is required for the mechanical properties. The isocyanate polyurethane prepolymer is linked with the epoxy functionality through bisphenolic capping unit.

As is known in the art, toughening agents for epoxy adhesives, generally comprising elastomeric polyurethanes or polyureas, contain rigid and flexible components (hard and soft segments). The toughening ability of these compositions is generally attributed to the soft segments.

1. Inventive Toughener

The present invention is directed to a capped toughening composition that is reacted with a diglycidyl ether bisphenol epoxy resin.

In general, a toughener, preferably a PU prepolymer, is terminally capped, preferably with two (e.g., difunctional) aromatic —OH groups, more preferably bisphenolic capping units. The terminally-capped prepolymer is reacted with an epoxy resin, thereby obtaining the inventive toughener. These reactions may be carried out sequentially or concurrently. Regardless whether the reactions are sequential or concurrent, the resulting product may be referred to as a reaction product of an epoxy resin with a composition that is itself a reaction product of a prepolymer and a capping group. The inventive toughener may also be referred to as a reaction product of an isocyanate terminated prepolymer; a polyphenol or a dihydroxy functional benzene; and a diglycidyl bisphenol epoxy resin.

When a sequential process is used to prepare an inventive toughener, any phenolic-capped toughening composition (i.e., capping group with a remaining unreacted phenolic hydroxy), preferably a bisphenol-terminated polyurethane mono- or co-prepolymer, may be used. Examples of suitable capped toughening compositions are disclosed in U.S. Pat. Nos. 5,278,257 and 7,557,168, the disclosures of which are incorporated herein by reference in their entireties.

U.S. Pat. No. 5,278,257 discloses toughening compositions comprising a phenol-terminated polyurethane, polyurea or polyurea-urethane of formula I:

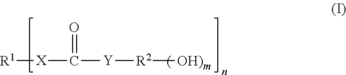

in which m is 1 or 2, n is 2 to 6, R¹ is the n-valent radical of an elastomeric prepolymer, after the removal of the terminal isocyanate, amino or hydroxyl groups, which is soluble or dispersible in epoxide resins, X and Y independently of one another are —O— or —NR³—, it being necessary for at least one of these groups to be —NR³—, R² is an m+1-valent radical of a polyphenol or aminophenol after the removal of the phenolic hydroxy group(s) or the amino group or both the amino group and the phenolic hydroxyl group, respectively, and R³ is hydrogen, C₁-C₆ alkyl or phenol.

The toughener component of U.S. Pat. No. 5,278,257 is a selected polyurethane or a selected polyurea derived from a specific prepolymer. The term “elastomeric prepolymer radical R¹” is to be understood, within the scope of this description, as meaning a radical, terminated with n-isocyanate, n-amino or n-hydroxyl groups, of a prepolymer which, after these groups have been capped, results in a phenol-terminated polyurethane, polyurea or polyurea-urethane of the formula I (component (B)) which, in combination with the diene component A) and epoxide resins C), produces, after curing, an elastomer phase or a mixture of elastomer phases. These can be homogeneous or heterogeneous combinations of components A), B) and C). The elastomer phase(s) is(are), as a rule, characterized by a glass transition temperature below 0° C. The term “prepolymer which is soluble or dispersible in epoxide resins” is to be understood, within the scope of this description, as meaning a radical, terminated by n-isocyanate, n-amino or n-hydroxyl groups, of a prepolymer which, after these groups have been capped, results in a phenol-terminated polyurethane, polyurea or polyurea-urethane of formula I which is soluble, or is dispersible without further assistance, for example emulsifiers, in an epoxide resin or in a combination of an epoxide resin and a diene copolymer; in the course of this, therefore, a homogeneous phase is formed or at least no macroscopic phase separation of one of the components or of a mixture of the components takes place.

As described in of U.S. Pat. No. 5,278,257, the phenol-terminated polyurethane, polyurea or polyurea-urethane of formula I is preferably a phenol-terminated polyurethane, polyurea or polyurea-urethane insoluble in water. This is to be understood, within the scope of this description, as meaning a phenol-terminated polyurethane, polyurea or polyurea-urethane which dissolves in water to the extent of less than 5% by weight, preferably less than 0.5% by weight, and which, when stored in water, absorbs only a small amount of water, preferably less than 5% by weight, in particular less than 0.5% by weight, or which, in the course thereof, exhibits only a slight swelling.

In U.S. Pat. No. 5,278,257, the prepolymers on which R¹ is based have, as a rule, molecular weights (number average) of 150 to 10,000, preferably 1,800 to 3,000. The average functionality of these prepolymers is at least two, preferably 2 to 3 and particularly preferably 2 to 2.5.

U.S. Pat. No. 7,557,168 describes toughener components that comprise the reaction product of one or more isocyanate terminated prepolymers with one or more capping agents, wherein the isocyanate used to prepare the prepolymer has aliphatic and/or cycloaliphatic groups. Preferably, the prepolymer has a molecular weight so as to result in a low viscosity adhesive composition. Preferably, the viscosity of the prepolymer is from about 20 Pas. or greater, more preferably about 100 Pas. or greater. Preferably, the prepolymer has a viscosity of about 1000 Pas. or less and more preferably about 800 Pas. or less. In order to achieve the desired viscosity of the toughening agent, the number of branches of the isocyanate prepolymer and the crosslink density of the ultimate reaction product must be kept low. The number of branches of the prepolymer is directly related to the functionality of the raw materials used to prepare the isocyanate terminated prepolymer. Functionality refers to the number of reactive groups in the reactants. Preferably the number of branches in the prepolymer is about 6 or less and more preferably about 4 or less. Preferably the number of branches is about 1 or greater and more preferably about 2 or greater. Crosslink density is the number of attachments between chains of polymers. At higher crosslink densities the viscosity of the reaction product is higher. The crosslink density is impacted by the functionality of the prepolymer and by the process conditions. If the temperature of the reaction to prepare the toughening agent is kept relatively low, crosslinking can be minimized preferably the crosslink density is about 2 or less and more preferably about 1 or less. Preferably, the molecular weight of the prepolymer is about 8,000 (Mw) or greater, and more preferably about 15,000 (Mw) or greater. Preferably, the molecular weight of the prepolymer is about 40,000 (Mw) or less, and more preferably about 30,000 (Mw) or less. Molecular weights as used herein are weight average molecular weights determined according to GPC analysis. The amount of capping agent reacted with the prepolymer should be sufficient to cap substantially all of the terminal isocyanate groups. What is meant by capping the terminal isocyanate groups with a capping agent is that the capping agent reacts with the isocyanate to place the capping agent on the end of the polymer. What is meant by substantially all is that a minor amount of free isocyanate groups are left in the prepolymer. A minor amount means an amount of the referenced feature or ingredient is present which does not impact in any significant way the properties of the composition. Preferably, the ratio of capping agent equivalents to isocyanate prepolymer equivalents is about 1:1 or greater, more preferably about 1.5:1 or greater. Preferably, the equivalents ratio of capping agent to isocyanate of prepolymer is about 2.5:1 or less and more preferably about 2:1 or less.

Preferably, the reaction product of U.S. Pat. No. 7,557,168 corresponds to one of the formulas II or III:

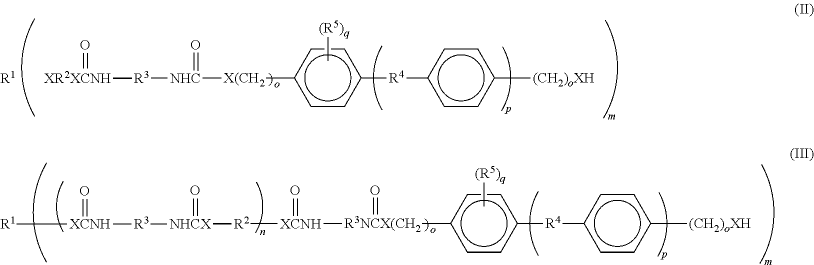

where:
R¹ is independently in each occurrence a C₂₋₂₀ m-valent alkyl moiety;
R² is independently in each occurrence a polyether chain;
R³ is independently in each occurrence an alkylene, cycloalkylene or mixed alkylene and cycloalkylene moiety, optionally containing one or more oxygen or sulfur atoms;
R⁴ is a direct bond or an alkylene, carbonyl, oxygen, carboxyloxy, or amido moiety;
R⁵ is independently in each occurrence an alkyl, alkenyl, alkoxy, aryloxy or aryloxy moiety with the proviso that if p=1, then q=0;
X is O or —NR⁶ with the proviso that X is O where p is 1; and that where p is 0, X is O in at least one occurrence;
R⁶ is independently in each occurrence hydrogen or alkyl;
m is independently in each occurrence a number of about 1 to about 6;
n is independently in each occurrence a number of 1 or greater;
o is independently in each occurrence 0 or 1 if p is 0 and 0 if p is 1;
p is independently in each occurrence 0, or 1; and
q is independently in each occurrence a number of from 0 to 1.

The isocyanate terminated prepolymer of U.S. Pat. No. 7,557,168 corresponds to one of formulas IV and V:

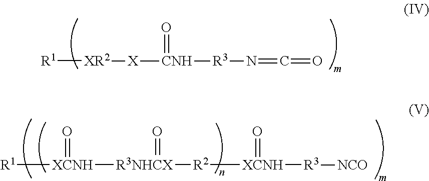

and capping compound corresponds to formula VI:

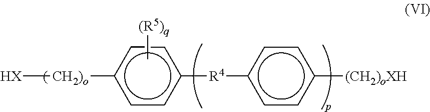

wherein R¹, R², R³, R⁴, R⁵, m, n, o, p and q are as defined above.

In the reaction product of U.S. Pat. No. 7,557,168, R⁴ is preferably a direct bond or an alkylene, oxygen, carbonyl, carbonyloxy, or amido moiety. More preferably, R⁴ is a direct bond or a C₁₋₃ straight or branched alkylene moiety. Preferably R⁵ is independently in each occurrence an alkyl, alkenyl, alkyloxy or aryloxy moiety with the proviso that if p=1 then q=0. More preferably R⁵ is a C₁₋₂₀ alkyl, C₁₋₂₀ alkenyl, C₁₋₂₀ alkoxy or C₆₋₂₀ aryloxy moiety. More preferably, R⁵ is a C₃₋₁₅ alkyl or C₂₋₁₅ alkenyl moiety. Preferably, o is 0. Preferably, n is independently in each occurrence about 1 to about 3.

Any suitable compound containing two or more phenolic hydroxy groups, including those disclosed in U.S. Pat. Nos. 5,278,257 and 7,557,168, may be used to cap the above toughening compositions. Preferred capping compounds comprise exactly two phenolic hydroxy groups. Some suitable capping compounds include resorcinol, catechol, hydroquinone, biphenyl-4, 4 diol, bisphenol A, bisphenol B, Bisphenol C, Bisphenol E, bisphenol AP (1,1-bis(4-hydroxylphenyl)-1-phenyl ethane), bisphenol F, bisphenol K, bisphenol M, tetramethylbiphenol and o,o′-diallyl-bisphenol A (ODBA), and the like. ODBA is preferred. Resorcinol is meant to include resorcinol as well as derivative thereof, such as substituted resorcinols. A. R. L. Dohme, The Preparation of the Acyl and Alkyl Derivatives of Resorcinol, JACS, 1926, 48(6), pp 1688-1693 (incorporated by reference in its entirety). As used herein, the term “di-functional aromatic moiety” is intended to include all substituted and dihydroxy-substituted di-functional aromatic compounds, as well as derivatives thereof, preferably dihydroxy-substituted and derivatives thereof.

Any epoxy resin that can react with a capped toughener can be used in the invention. A low molecular weight and/or liquid epoxy resin is preferred. If the molecular weight of the epoxy resin is too high, this can cause processing problems and excessive increases in viscosity as the reaction proceeds. Preferred epoxy resins include liquid epoxy resins, including those described in more detail in section 2 below. Some preferred epoxy resins for blocking the toughener include D.E.R. 330, D.E.R. 331, and D.E.R. 383.

The toughener capped with groups having reactive aromatic hydroxy groups is reacted with an epoxy resin to provide the inventive compounds. Any method for performing the reaction can be used, and can be devised by a person of ordinary skill in the art using this disclosure as motivation and/or guide.

A catalyst may be used to promote the reaction between the capped PU prepolymer and the epoxy resin. Some preferred catalysts include ethyltriphenylphosphonium acetate (ETPAc), tetrabutyl ammonium bromide (TBAB), and triphenyl phosphine (TPP). In order to limit the increase in epoxy equivalent weight (EEW) as the reaction proceeds, a catalyst quenching agent, such as methyl toluene-4-sulfonate (MPTS), can be added during the reaction. When used, the quenching agent can be added, e.g., after a predetermined time (e.g., 6 hours of reaction time), after a certain target EEW has been reached (e.g., 300, 350, 400, or 500 g/equiv.), or when some other criterion has been met (e.g., color change).

The inventive toughener can have any molecular weight suitable for use as a toughener, as can be determined by one of ordinary skill in the art. If the molecular weight is too high, then the toughener may become too viscous, or solidify, which can compromise its effectiveness and ease of use. There is generally no preferred lower limit to the molecular weight, but the toughener should be of high enough molecular weight to have sufficient soft segments to act as a toughener. If, for example, a bisphenol-capped PU toughener is of sufficient molecular weight to act as a toughener, then it should have sufficient molecular weight to be suitable for use in the present invention. In general, higher molecular weights confer better mechanical properties to the cured adhesive. Preferred mass-weighted molecular weights (Mw) are at or above 5,000 Da, 6,000 Da, 10,000 Da, 14,000 Da, or 17,000 Da. While there is no particular upper limit, Mw will generally be less than or equal to 30,000 Da, 25,000 Da, or 20,000 Da. Mw's from the Examples are also preferred. Preferred number-weighted molecular weights (Mn) are at or above 3,000 Da, 4,000 Da, or 6,000 Da. While there is no particular upper limit, Mn will generally be less than or equal to 15,000 Da or 10,000 Da. Mw's and Mn's from the Examples are also preferred. Ranges formed from pairs of Mw's, or pairs of Mn's, of these values are also preferred.

Inventive adhesives and methods according to the present invention comprise one or more inventive toughener according to the present invention. Inventive adhesive compositions and methods may comprise any amount of inventive toughener. Preferably, the inventive adhesive composition comprises more than or about 20 wt %, more preferably more than or about 25 wt %, or 30 wt % inventive toughener, based on weight of the epoxy adhesive composition. Preferably, inventive adhesive composition comprises less than or about 60 wt %, more preferably less than or about 50 wt % or 45 wt % inventive toughener, based on weight of the epoxy adhesive composition. Other preferred amounts are shown in the Examples. Ranges formed from pairs of these values (e.g., 20 to 60 wt % and 30 to 40 wt % (adhesive BH)) are also preferred. It should be understood that the inventive toughener composition may comprise converted blocked PU reacted with epoxy, and will generally also comprise unreacted epoxy resin. The above percentages of inventive toughener include the unreacted epoxy resin.

2. Epoxy Resins

Epoxy resins useful in adhesive compositions according to this invention include a wide variety of curable epoxy compounds and combinations thereof. Useful epoxy resins include liquids, solids, and mixtures thereof. Typically, the epoxy compounds are epoxy resins which are also referred to as polyepoxides. Polyepoxides useful herein can be monomeric (e.g., the diglycidyl ether of bisphenol A, diglycidyl ether of bisphenol F, diglycidyl ether of tetrabromobisphenol A, novolac-based epoxy resins, and tris-functional epoxy resins), higher molecular weight resins (e.g., the diglycidyl ether of bisphenol A advanced with bisphenol A) or polymerized unsaturated monoepoxides (e.g., glycidyl acrylates, glycidyl methacrylate, allyl glycidyl ether, etc.) to homopolymers or copolymers. Most desirably, epoxy compounds contain, on the average, at least one pendant or terminal 1,2-epoxy group (i.e., vicinal epoxy group) per molecule. Solid epoxy resins that may be used in the present invention preferably can comprise or preferably be based upon mainly bisphenol A. However, the amount of bisphenol A used should be kept below 0.5 wt % of the adhesive composition in order to achieve the viscosity profile of the present invention. Some preferred epoxy resins include, for example, D.E.R. 330, D.E.R. 331, and D.E.R. 671, all commercially available from The Dow Chemical Company.

One preferable epoxy resin has general formula:

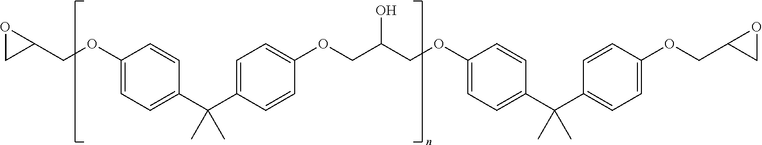

where n is generally in the range of 0 to about 25. Basic liquid resins, e.g., D.E.R. 331, have epoxy equivalent weights in the range of about 180 to 195 g/mol.

Combinations of epoxy resins may be used to adjust properties of the epoxy adhesive. In compositions and methods of the present invention, the epoxy adhesive may comprise any amount of epoxy resin. Preferably, the liquid and/or solid epoxy resin comprise more than or about 20 wt %, more preferably more than or about 25 wt %, 30 wt % or 35 wt %, of the epoxy adhesive. Preferably, the liquid and/or solid epoxy resin comprise less than or about 65 wt %, more preferably less than or about 55 wt % or 45 wt %, of the epoxy adhesive. Other preferred amounts are shown in the Examples. Ranges formed from pairs of these values (e.g., 25 to 35 wt %, 25 to 65 wt %, 30 to 38 wt % (adhesive AA)) are also preferred.

When a combination of liquid and solid epoxy resins is used, any proportion can be used, and can be determined by one of ordinary skill in the art. In order to obtain a suitable viscosity, it is generally preferred that the weight proportion of liquid to solid epoxy resin is greater than 50:50. Epoxy adhesive compositions of the present invention preferably comprise liquid and solid epoxy resins in a ratio of, or greater than, 55:45, 65:35, or 70:30. Epoxy adhesive compositions of the present invention preferably comprise liquid and solid epoxy resins in a ratio of, or less than, 100:0, 99:1, 90:10, or 85:10. Other preferred ratios are shown in the Examples. Ranges formed from pairs of these values (e.g. 50:50 to 100:0, 65:35 to 82:18 (adhesive AU)) are also preferred.

3. Hardener

The hardener, preferably suitable for a 1K adhesive composition, preferably comprises a latent hardener. Any latent hardener that does not cause hardening under ambient conditions (“ambient conditions” meaning, e.g., typical room temperature and normal lighting conditions) may be used. A latent hardener that causes the epoxy adhesive to be curable by application of heat is preferred. Some preferred hardeners include dicyandiamide, imidazoles, amines, amides, polyhydric phenols, and polyanhydrides. Dicyandiamide (also known as DICY, dicyanodiamide, and 1- or 2-cyanoguanidine) is preferred. DICY (CAS 461-58-5) has empirical formula C₂N₄H₄, molecular weight 84, and structural formula:

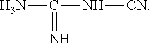

Any amount of hardener may be used as appropriate for any particular composition according to the present invention. The amount of hardener is preferably at least 1 wt %, more preferably at least 2 wt %, more preferably at least 3 wt % of the epoxy adhesive. The amount of epoxy hardener is preferably up to about 6 wt %, more preferably up to about 6 wt %, 5 wt % or 4 wt % of the epoxy adhesive. Other preferred amounts are shown in the Examples. Ranges formed from pairs of these values (e.g., 1 to 3 wt % or 3 to 6 wt %) are also preferred.

4. Curing Accelerator

One or more curing accelerators (catalysts) may be optionally used to, e.g., modify the conditions under which a latent catalyst becomes catalytically active. When used, a preferred curing accelerator may include amines, such as amino phenols, ureas and imidazoles. More preferred accelerators include amines, such as amino phenols. A preferred accelerator includes 2,4,6-tris(dimethylaminomethyl)phenol integrated into a poly(p-vinylphenol) matrix as described in EP-A-0 197 892. More preferred accelerators include 2,4,6-tris(dimethylaminomethyl)phenol integrated into a polyphenolic resin matrix as described in WO2012000171. Other accelerators can include 2,4,6-tris(dimethyl-aminomethyl)phenol integrated into a poly(p-vinylphenol) matrix, or Rezicure matrix such as described in U.S. Pat. No. 4,659,779 (and its family members U.S. Pat. Nos. 4,713,432 and 4,734,332; and EP-A-0 197 892). Other preferred curing accelerators include ureas such as OMICURE U52 and OMICURE 405 (Emerald Performance).

When used, curing accelerator may be present in any amount that suitably adjusts the activation condition of latent catalyst. A curing accelerator may be omitted altogether, or else be present in amounts more than or about 0.1 wt %, 0.2 wt %, 0.3 wt %, or 0.4 wt % of the epoxy adhesive. Preferably, curing accelerator may be present in amounts less than or about 4 wt %, 3 wt %, 2 wt %, or 1 wt % of the epoxy adhesive. Other preferred amounts are shown in the Examples. Ranges formed from pairs of these values (e.g., 0 to 3 wt %, 0.1 to 3 wt % or 1 to 3 wt %) are also preferred.

5. Rubber Components

Rubber components, including liquid rubber or core-shell rubber may be optionally used in the present invention. Some preferred liquid rubber and core-shell rubber compositions are disclosed in U.S. Pat. Nos. 7,642,316 and 7,625,977, both of which are incorporated herein in their entireties.

When a liquid rubber is used, a preferred type is a nitrile rubber modified epoxy resin based on DGEBA. Some preferred rubber modified epoxy resins are commercially available from Schill & Seilacher under the trade name Struktol®, e.g., Struktol® 3604 or 3614.

When a core shell rubber is used, a preferred type is of the kind described in U.S. 2007/0027233 (EP 1 632 533 A1), incorporated herein by reference in its entirety. Core-shell rubber particles as described in the document include a crosslinked rubber core, in most cases being a crosslinked copolymer of butadiene, and a shell which is preferably a copolymer of styrene, methyl methacrylate, glycidyl methacrylate and optionally acrylonitrile. The core-shell rubber is preferably dispersed in a polymer or an epoxy resin, also as described in the document.

Preferred core-shell rubbers (CSRs) include those sold by The Dow Chemical Company under the designation Fortegra, preferably including the 300-series, such as Fortegra 301. Other preferred core shell rubbers include products available from Kaneka Corporation under the designation Kaneka Kane Ace, including the Kaneka Kane Ace 15 and 120 series of products, including Kaneka Kane Ace MX 153, Kaneka Kane Ace MX 156 and Kaneka Kane Ace MX 120 core-shell rubber dispersions, and mixtures thereof. The products contain the core-shell rubber particles pre-dispersed in an epoxy resin, at concentrations of approximately 33% or 25%.

6. Other Components

Other components may optionally be used in adhesives according to the present invention, such as fillers, spacers, adhesion promoters, pigments, thixotropic agents, wetting agents, reactive diluents, antioxidants, etc.

Products such as glass beads may be used to fill adhesive and/or as a spacer, e.g., to help control layer thickness of adhesive applied to a surface. The type and size of such products may be determined by one of ordinary skill in the art for the intended application. Some preferred products include Spheriglass (Potter Industries).

Optional fillers include mineral fillers, such as hollow glass spheres, calcium carbonate, calcium oxide, and talc. Fillers ensure good failure mode behavior, increased humidity resistance, improved corrosion resistance, increased modulus and/or superior processability. Calcium carbonate (e.g., sold under trade name OMYA®), which can be used to reduce shrinkage and increase corrosion resistance. Calcium oxide (e.g., sold under the trade name CHAUX VIVE) is a humidity scavenger that may help to preserve a partially-cured epoxy adhesive prior to final curing. Talc is available, e.g., under the trade name MISTROFIL® or SIERALITE®, and aluminum magnesium silicate (wollastonite) is available, e.g., under the trade name NYAD® 200. Silica, preferably hydrophobic fumed silica may also be used, such as AEROSIL R202 or AEROSIL R805. Some preferred hollow glass spheres include Glass Bubbles (3M).

When used, fillers and spacers (e.g., glass spheres) may be present in any useful amount, and can be determined by those of ordinary skill in the art using this document as guidance. Typically, fillers may be present in amounts more than or about 5 wt %, 10 wt %, or 15 wt % of the epoxy adhesive. Fillers may be present in amounts less than or about 30 wt %, 25 wt %, or 20 wt % of the epoxy adhesive. Other preferred amounts are shown in the Examples. Ranges formed from pairs of these values are also preferred.

Reactive and non-reactive diluents may also optionally be used. Some preferred reactive diluents include monoglycidyl esters of neodecanoic acid, which also can act as a viscosity-reducing agent. They are commercially available, e.g., under the trade name ERISYS GS-110 (Emerald) and CARDURA E10 (Momentive).

Thixotropic agents and other viscosity regulators may also be optionally used. One such preferred example includes fumed silica (e.g., sold under the trade name Aerosil®). A preferred thixotropic agent that also improves wash-off resistance is a mixture of polyester and liquid epoxy resin (LER), such as Dynacol (25% polyester 7330 and 75% LER 330). Castor oil wax with polyamides may also be used, and are commercially available from Rockwood under the trade name Rheotix, e.g., Rheotix 240.

When used, any appropriate gelling agent can be included. Preferred gelling agents should comprise functional groups that are capable of reacting with an epoxy resin. These include thermoplastic compounds such as polyesterdiols, polyamides, or polyvinyl butyral.

Examples of suitable gelling agents include polyesterdiols, e.g., Dynacoll® 7330 available from Evonik. Castor oil wax with polyamides may also be used, and is commercially available from Rockwood under the trade name Rheotix, e.g., Rheotix 240. Other suitable gelling agents include Luvotix grades (like Luvotix HP) supplied from Lehmann, and Voss which is a polyamide without the wax or Disparlon grades supplied from Kusumoto Chemicals Ltd. Suitable polyvinyl butyrals include Mowital B 60H and Mowital B 60HH from Kuraray. These gelling agents may be used alone or in combination with each other in the adhesive composition.

When used, thixotropic and/or gelling agents may each be present in an amount more than or about 0.5 wt % or 1 wt % of the epoxy adhesive, and/or amounts less than or about 5 wt % or 3 wt % of the epoxy adhesive. Other preferred amounts are shown in the Examples. Ranges formed from pairs of these values are also preferred.

The inventive tougheners can be used in 1-component (1K) or 2-component (2K) epoxy adhesive compositions, preferably 1K compositions.

The invention includes adhesives comprising the inventive tougheners, methods of using the tougheners and products (e.g., adhesive compositions) comprising them, as well as cured inventive adhesives and products comprising them.

### EXAMPLES

Some of the materials used in the following Examples are listed in Table 1, along with some known suppliers or suggestions for manufacturing.

TABLE 1

| | Supplier | Chemistry and/or role |
|---|---|---|
| D.E.R. 330 | Dow | Liquid DGEBA resin |
| D.E.R. 671 | Dow | Solid DGEBA resin |
| DIPA-capped PU | | U.S. Pat. No. 8,404,787; |
| | | Example 2 |
| ODBA-capped PU | | U.S. Pat. No. 5,278,257; |
| | | Example 13 |
| Silquest A 187 | Momentive | Epoxy silane |
| FC 4430 | 3M | Wetting agent |
| CARDURA E10 | Momentive | Reactive diluent |
| Amicure CG 1200 | Airproducts | dicyandiamide |
| Curing accelerator | | U.S. Pat. No. 9,000,120 B2, |
| (2,4,6-tris(dimethyl- | | example 1 |
| aminomethyl)phenol | | |
| integrated into a | | |
| polyphenolic resin matrix) | | |
| Omya BSH | Omya | calcium carbonate |
| Chaux vive | Lhoist | calcium oxide |
| Talc 1N | IMCD | Talc |
| | Deutschland | |
| Mowital B60HH | Kuraray | polyvinylbutyral |
| Glass Bubbles K25 | 3M | Hollow glass spheres |
| Colorant | Huntsman | Dye |

### Example 1 (Epoxy Capping of Toughener) Sequential Path

Toughener ODBA-capped PU is capped with epoxy functionality (DER 338) using the following procedures. The reactions are run targeting an epoxy equivalent weight (EEW) of 300 g/equiv. (11:1 molar ratio DER 383: ODBA-capped PU) at 100° C. One run is done with ETPAc (ethyltriphenylphosphonium acetate) and another with TPP (triphenyl phosphine) as catalysts at 0.05 wt % loading. TPP catalyst is the control system. DER 330 has a molecular weight of 360, and RAM 965 has molecular weight of 1900, both DER 330 and ODBA-capped PU having a functionality of 2 or higher.

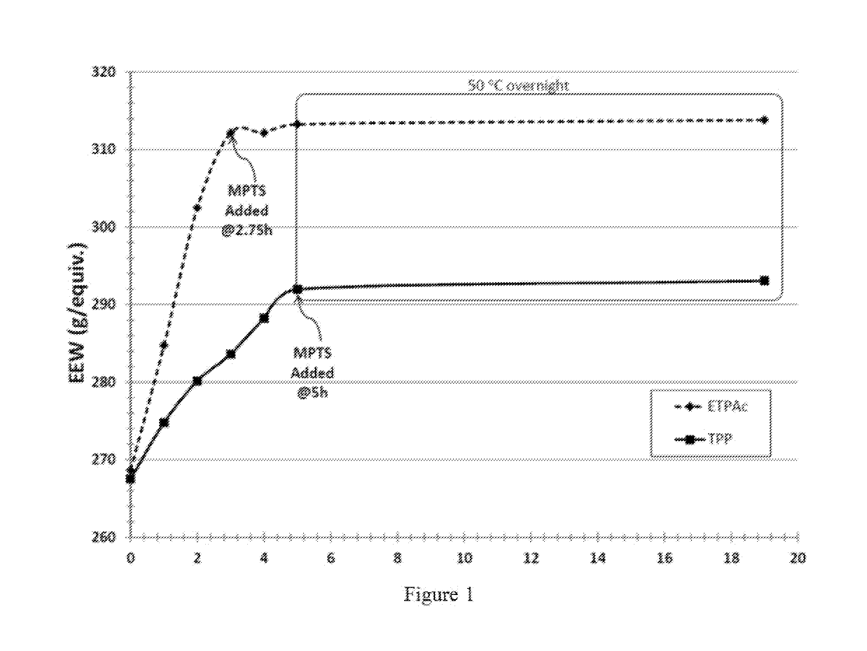

When the target EEW is reached, the catalyst is quenched with methyl toluene-4-sulfonate (MPTS). As a test, heating is continued heating overnight to see if consumption of the epoxy occurs. It is observed that quenching the catalyst stops the further progression of the reaction as indicated by stabilized EEW in FIG. 1.

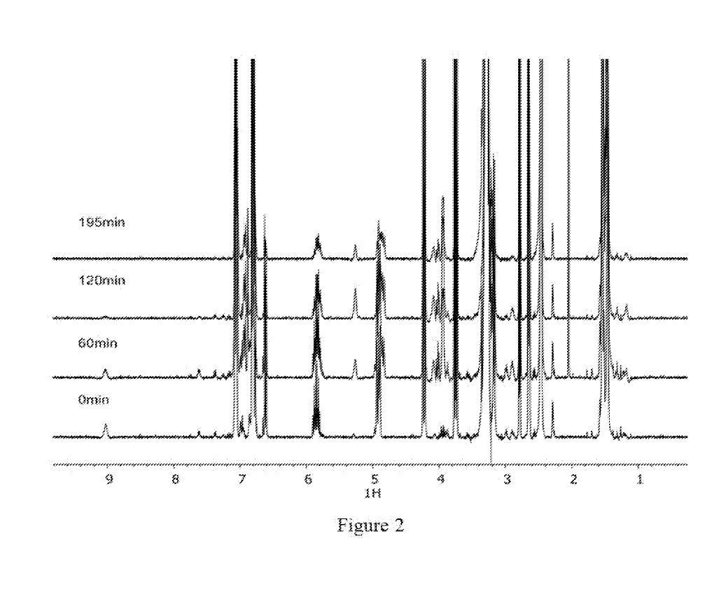

NMR spectra are collected on the ETPAc-catalyzed material from FIG. 1. As shown in FIG. 2, ¹H NMR spectroscopy can be used to show that the phenolic —OH functionality is consumed during the reaction. As the reaction progresses, the phenolic —OH signal (9.0 ppm) decreases, and when the target EEW is reached, the signal is no longer significant. From top to bottom, the lines in FIG. 2 correspond to t=0 hr, t=1 hr, t=2 hr, and t=3.25 hr.

### Example 2 (Inventive Tougheners) In Situ Coupling

Inventive tougheners in Series A (tougheners A-E, U, and V) are prepared with 1,6-hexamethylene diisocyanate (HDI) as isocyanate compound. Inventive tougheners in Series B (tougheners F-J and T) are prepared with isophoronediisocyanate (IPDI) instead of HDI.

Mass-weighted (Mw) and number-weighted (Mn) molecular weights are measured by GPC analysis (DIONEX) with a Viscotek dual detector (Viscotek) using Omnisec software to obtain absolute molecular weights.

TABLE 2
Inventive tougheners

| | A | B | C | D | E | F | G |
|---|---|---|---|---|---|---|---|
| Wt % | [%] | [%] | [%] | [%] | [%] | [%] | [%] |
| PolyTHF 2900 | | | | | 41.62 | | |
| PolyTHF 2000 | 32.93 | | | | | 32.39 | |
| PolyTHF 1700 | | 28.85 | | | | | 28.28 |
| PolyTHF 1400 | | | 25.79 | | | | |
| PolyTHF 1000 | | | | 19.71 | | | |
| PolyBd R45 HTLO | | | | | | | |
| HDI | 5.54 | 5.89 | 6.20 | 6.63 | 4.83 | | |
| Trimethylolpropane | | | | | | | |
| IPDI | | | | | | 7.20 | 7.63 |
| DBTL | 0.05 | 0.05 | 0.07 | 0.07 | 0.07 | 0.05 | 0.07 |
| ODBA 93% | 11.28 | 11.99 | 12.62 | 13.52 | 9.83 | 11.09 | 11.78 |
| DER 331 | 50.00 | 53.02 | 55.12 | 59.87 | 43.45 | 49.07 | 52.04 |
| DER 330 | | | | | | | |
| Triphenylphosphine | 0.20 | 0.20 | 0.20 | 0.20 | 0.20 | 0.20 | 0.20 |
| Methyltoluol-4-sulfonate | | | | | | | |
| Ethyltriphenylphosphonium | | | | | | | |
| acetate | | | | | | | |
| Tetrabutylammoniumbromide | | | | | | | |
| Total: | 100.00 | 100.00 | 100.00 | 100.00 | 100.00 | 100.00 | 100.00 |
| Mn [Da] | 8,300 | 7,600 | 7,900 | 6,300 | 9,000 | 5,000 | 4,300 |
| Mw [Da] | 17,200 | 13,700 | 16,600 | 15,500 | 17,400 | 7,800 | 6,400 |
| Epoxy Equiv. | 427 | 402 | 388 | 356 | 491 | 435 | 410 |
| Weight (EEW) | | | | | | | |

| | H | I | J | T | U | V |
|---|---|---|---|---|---|---|
| Wt % | [%] | [%] | [%] | [%] | [%] | [%] |
| PolyTHF 2900 | | | 40.98 | | | |
| PolyTHF 2000 | | | | 18.18 | 32.38 | 31.95 |
| PolyTHF 1700 | | | | | | |
| PolyTHF 1400 | 25.11 | | | | | |
| PolyTHF 1000 | | 19.29 | | | | |
| PolyBd R45 HTLO | | | | 8.93 | | |
| HDI | | | | | 4.97 | 4.91 |
| Trimethylolpropane | | | | 0.14 | 0.17 | 0.17 |
| IPDI | 7.97 | 8.58 | 6.28 | 5.82 | | |
| DBTL | 0.07 | 0.07 | 0.07 | 0.06 | 0.04 | 0.04 |
| ODBA 93% | 12.28 | 13.24 | 9.68 | 12.25 | 12.35 | 12.17 |
| DER 331 | 54.37 | 58.62 | 42.79 | | | |
| DER 330 | | | | 54.46 | 49.93 | 49.24 |
| Triphenylphosphine | 0.20 | 0.20 | 0.20 | | | 0.20 |
| Methyltoluol-4-sulfonate | | | | 0.11 | 0.11 | 1.32 |
| Ethyltriphenylphosphonium | | | | 0.05 | | |
| acetate | | | | | | |
| Tetrabutylammoniumbromide | | | | | 0.05 | |
| Total: | 100.00 | 100.00 | 100.00 | 100.00 | 100.00 | 100.00 |
| Mn [Da] | 4,600 | 4,700 | 6,400 | — | — | — |
| Mw [Da] | 6,800 | 7,000 | 11,000 | — | — | — |
| Epoxy Equiv. | 392 | 364 | 499 | 398 | 444 | 444 |
| Weight (EEW) | | | | | | |

In situ coupling: To prepare inventive tougheners A-J, the indicated wt % of polytetrahydrofuran diol (polyTHF) is added to a lab reactor and heated to 120° C. The polytetrahydrofuran diol is mixed for 30 min at 120° C. under vacuum, then cooled to 60° C. Once the temperature reaches 60° C., the indicated wt % of the diisocyanate (HDI or IDPI) is added and mixed for 2 min. The indicated wt % DBTL (Sigma Aldrich) is added and the mixture is allowed to react at 85° C. (bath temperature) for 45 min under nitrogen.

The indicated wt % of o,o′-diallylbisphenol A and DER 331 (LER) are added and the mixture is stirred until the material temperature reaches 80° C.

A sample of the mixture is taken for NCO determination, measured according to ASTM D2572-97. NCO should be 0%. If the NCO is greater than 0%, continue the reaction until the NCO reaches 0%.

Once NCO is 0%, indicated weight % of the catalyst TPP is added and the mixture is heated to 110° C. (material temp.) and is mixed under vacuum until the color changes from orange to deep red, about 30 minutes (e.g., 20-40 minutes). The oil bath is set to 100° C. and the mixture is mixed for an additional 30 min.

Tougheners T, U, and V are prepared by the same epoxidation process like tougheners A-J, but with additional catalyst deactivation.

Sequential coupling: Toughener T is prepared by mixing the indicated amounts of polytetrahydrofuran diole, polybutadiene diol, and trimethylolpropane, and heating at 120° C. under vacuum until homogeneous. The mixture is then cooled to 60° C. The diioscyanate is added with mixing. Dibutyl tin laurate (DBTL) catalyst is added, and the mixture is allowed to react at 85° C. for 45 min under nitrogen. o,o′-diallybisphenol A is added under mixing. The mixture is allowed to react for 90 min at 90° C. under nitrogen, then mixed for 10 min under vacuum.

Add the DER 330 and ethyltriphenylphosphonium acetate and let the mixture react at 100° C. (material temperature) for 150 min. Then add the methyltoluol-4-sulfonate and mix for an additional 10 min. Mix the mixture under vacuum for at least 10 more min.

Sequential coupling: Toughener U is prepared by mixing the indicated amounts of polytetrahydrofuran diol, and trimethylolpropane, and heating at 120° C. under vacuum until homogeneous. The mixture is then cooled to 60° C. The diioscyanate is added with mixing. Catalyst (DBTL) is added, and the mixture is allowed to react at 85° C. for 45 min under nitrogen. o,o′-diallybisphenol A is added under mixing. Let the mixture react for 45 min at 90° C. under nitrogen, then mix for 10 min under vacuum.

Add DER 330 and tetrabutylammoniumbromide and let the mixture react at 90° C. (material temperature) for 360 min. Then add methyltoluol-4-sulfonate and mix for an additional 10 min. Mix the mixture under vacuum for at least 10 more min.

Sequential coupling: Toughener V is prepared by mixing the indicated amounts of polytetrahydrofuran diol, and trimethylolpropane, and heating to 120° C. under vacuum until homogeneous. The mixture is then cooled to 60° C. The diioscyanate is added with mixing. Catalyst (DBTL) is added, and the mixture is allowed to react at 85° C. for 45 min under nitrogen. o,o′-diallybisphenol A is added while mixing. Let the mixture react for 45 min at 90° C. under nitrogen, then mix for 10 min under vacuum.

Add DER 330 and triphenylphosphine and heat the mixture to 110° C. (material temperature) and mix it under vacuum until the color change from orange to deep red. Set the oil bath to 100° C. and mix the mixture for additional 30 min. Then add methyltoluol-4-sulfonate and mix for an additional 10 min. Mix the mixture under vacuum for at least 10 more min.

### Example 3 (Comparative Tougheners)

Comparative tougheners Q and R use ODBA blocking and are not further reacted with liquid epoxy resin. Their stabilities are compared to the inventive toughener formulations within the prepared adhesive formulations. Comparative toughener Q is a linear ODBA-capped PU polymer, R is a branched ODBA-capped PU polymer, and S is a branched DIPA-capped PU polymer.

TABLE 3
Comparative tougheners

| | Q | R | S |
|---|---|---|---|
| Wt % | [%] | [%] | [%] |
| PolyTHF 2000 | 63.11 | 64.89 | 79.31 |
| HDI | 10.61 | 9.98 | 13.29 |
| Trimethylolpropane | | 0.33 | 0.54 |
| DBTL | 0.06 | 0.05 | 0.06 |
| ODBA 93% | 26.22 | 24.75 | |
| Diisopropylamine | | | 6.8 |
| Total: | 100.00 | 100.00 | 100 |
| Mn [Da] | 4400 | 6200 | 5100 |
| Mw [Da] | 8200 | 13900 | 10500 |

Comparative tougheners Q and R are prepared by mixing the indicated wt % polytetrahydrofuran diol and trimethylolpropane and heating to 120° C. under vacuum until homogeneous. The mixture is cooled to 60° C. The indicated wt % of the diioscyanate is added with mixing. The indicated wt % of catalyst is added, and the mixture is allowed to react at 85° C. for 25 min. The mixture is then cooled to 60° C., and the mixture is reacted for an additional 20 min. The resulting prepolymer is then capped/chain extended by reaction with the indicated wt % of o,o-diallybisphenol A for 30 min. The resulting mixture is then mixed for at least 10 min under vacuum.

Comparative toughener S is prepared by mixing the indicated amounts of polytetrahydrofuran diole and trimethylolpropane and heating to 120° C. under vacuum until homogeneous. The mixture is cooled to 60° C. The indicated wt % of the diioscyanate is added with mixing. The indicated wt % of catalyst is added, and the mixture is allowed to react at 85° C. for 25 min. The mixture is then cooled to 60° C., and is reacted for an additional 20 min. The resulting prepolymer is then capped by reaction with the indicated wt % of diisopropylamine for 30 min, then mixed under vacuum for at least 10 min.

### Example 4 (Adhesive Formulations)

Seven adhesive formulations, designated AA-AE, AU, and AV, are prepared in formulation series A, using inventive tougheners A-E, U and V. Formulation details and description are summarized in Table 4.

TABLE 4
Formulation series A using tougheners A-E.

| Raw materials | AA | AB | AC | AD | AE | AU | AV |
|---|---|---|---|---|---|---|---|
| Toughener | | | | | | | |
| Total Toughener | 18.1 | 18.1 | 18.1 | 18.1 | 18.1 | 20.0 | 20.00 |
| Content* | | | | | | | |
| DER 330 | 5.0 | 5.0 | 5.0 | 5.0 | 5.0 | 16.29 | 16.29 |
| LER D.E.R. 330/solid | 32.6 | 30.34 | 28.43 | 23.61 | 36.47 | 18.50 | 18.50 |
| epoxy resin D.E.R. | | | | | | | |
| 671 blend (67/33) | | | | | | | |
| Reactive diluents | 1 | 1 | 1 | 1 | 1 | | |
| Silane adhesion | 0.58 | 0.58 | 0.58 | 0.58 | 0.58 | 0.60 | 0.60 |
| promotor A 187 | | | | | | | |
| Wetting agent | 0.3 | 0.3 | 0.3 | 0.3 | 0.3 | | |
| Colorant | 0.39 | 0.39 | 0.39 | 0.39 | 0.39 | 0.40 | 0.40 |
| toughener A | 36.45 | | | | | | |
| toughener B | | 38.68 | | | | | |
| toughener C | | | 40.58 | | | | |
| toughener D | | | | 45.36 | | | |
| toughener E | | | | | 32.62 | | |
| toughener U | | | | | | 37.34 | |
| toughener V | | | | | | | 37.34 |
| Amicure CG 1200 | 3.79 | 3.82 | 3.83 | 3.87 | 3.75 | 5.27 | 5.27 |
| Curing accelerator | 0.84 | 0.84 | 0.84 | 0.84 | 0.84 | 0.80 | 0.80 |
| Mineral fillers** | 10.31 | 10.31 | 10.31 | 10.31 | 10.31 | 13.80 | 13.80 |
| Fumed silica mix | 8 | 8 | 8 | 8 | 8 | 5.00 | 5.00 |
| Glass bubbles K25 | | | | | | 2.00 | 2.00 |
| Mowital | 0.74 | 0.74 | 0.74 | 0.74 | 0.74 | 0 | 0 |

*This accounts for the flexible portion (soft segments) of the toughener that contributes to the toughening property (e.g., the polyurethane portion of the toughener). For example, a composition comprising 50 wt % toughener component, where the toughener component comprises 50 wt % soft PU portions, would have a Total Toughener Content of 25%.
**A combination of calcium oxide, calcium carbonate and talc.

Six adhesive formulations, designated BF-BJ and BT, are prepared in formulation series B, using inventive tougheners F-J and T. Three comparative adhesive formulations, designated RQ-RS, are prepared using comparative tougheners Q-S from Example 2. Formulation details and description are summarized in Table 5.

TABLE 5
Formulation series B using tougheners F-J and
T, and comparative tougheners Q, R and S

| Raw materials | BF | BG | BH | BI | BJ | BT | RQ | RR | RS |
|---|---|---|---|---|---|---|---|---|---|
| Toughener | | | | | | | ODBA | ODBA | DIPA |
| | | | | | | | capped | capped | |
| | | | | | | | and | | |
| | | | | | | | chain | | |
| | | | | | | | extended | | |
| Total Toughener | 18.1 | 18.1 | 18.1 | 18.1 | 18.1 | 20.00 | 18.1 | 18.1 | 18.1 |
| content | | | | | | | | | |
| DER 330 | 5.0 | 5.0 | 5.0 | 5.0 | 5.0 | 13.22 | 15.81 | 15.81 | 15.81 |
| LER/solid epoxy | 33.35 | 31.16 | 29.16 | 25.05 | 37.34 | 18.50 | 40.10 | 40.10 | 40.10 |
| resin blend | | | | | | | | | |
| Reactive diluent | 1 | 1 | 1 | 1 | 1 | | 1 | 1 | 1 |
| Silane adhesion | 0.58 | 0.58 | 0.58 | 0.58 | 0.58 | 0.60 | 0.58 | 0.58 | 0.58 |
| promotor A 187 | | | | | | | | | |
| Wetting agent | 0.3 | 0.3 | 0.3 | 0.3 | 0.3 | | 0.3 | 0.3 | 0.3 |
| Colorant | 0.39 | 0.39 | 0.39 | 0.39 | 0.39 | 0.40 | 0.39 | 0.39 | 0.39 |
| toughener F | 35.70 | | | | | | | | |
| toughener G | | 37.87 | | | | | | | |
| toughener H | | | 39.86 | | | | | | |
| toughener I | | | | 43.93 | | | | | |
| toughener J | | | | | 31.75 | | | | |
| toughener T | | | | | | 40.39 | | | |
| toughener Q | | | | | | | 18.1 | | |
| toughener R | | | | | | | | 18.1 | |
| toughener S | | | | | | | | | 18.1 |
| Amicure CG 1200 | 3.79 | 3.81 | 3.82 | 3.86 | 3.75 | 5.29 | 3.83 | 3.83 | 3.83 |
| Curing accelerator | 0.84 | 0.84 | 0.84 | 0.84 | 0.84 | 0.80 | 0.84 | 0.84 | 0.84 |
| Mineral fillers* | 10.31 | 10.31 | 10.31 | 10.31 | 10.31 | 13.80 | 10.31 | 10.31 | 10.31 |
| Fumed silica mix | 8 | 8 | 8 | 8 | 8 | 5.00 | 8 | 8 | 8 |
| glass bubbles K25 | | | | | | 2.00 | | | |
| Mowital | 0.74 | 0.74 | 0.74 | 0.74 | 0.74 | 0 | 0.74 | 0.74 | 0.74 |

The liquid epoxy resin D.E.R.™ 330, the liquid epoxy resin/solid epoxy resin blend, the reactive diluents, the silane adhesion promoter, the wetting agent, the colorant and the toughener, are combined and mixed vigorously for 5 minutes at 50° C. (50 rpm) followed by 20 minutes (150 rpm) under vacuum at the same temperature.

The fumed silica mix as well as the talc (part of the mineral fillers) are then added followed by mixing the composition for 5 minutes (50 rpm) while cooling to room temperature, followed by mixing for another 20 minutes (150 rpm) under vacuum.

Amicure® CG 1200G, the curing accelerator, the other part of the mineral fillers, the optional glass bubbles, and the Mowital, are then added followed by mixing for 3 minutes at a mixing speed of 50 rpm, and then for 15 minutes at 150 rpm under reduced atmospheric conditions.

### Example 5 (Adhesive Testing)

Rheological properties are tested as follows. Rotatory viscosity/yield stress: Bohlin CS-50 Rheometer, C/P 20, up/down 0.1-20 s/l; evaluation according to Casson model. Viscosity Casson: mathematical calculation of a viscosity factor using the Casson equation. Real viscosity values are measured at 45° C. at a shear rate of 10 s⁻¹.

Mechanical testing is performed on steel, e.g., HC220B-ZE-B (such as available from Thysssen Krupp). Curing is at 180° C. for 30 minutes. Lap shear strength is measured following DIN EN 1465: 10×25 mm bonded area, 0.2 mm adhesive layer thickness at a pull rate of 10 mm/min. Impact peel strength is measured following ISO 11343: 20×30 mm bonded area, 0.2 mm adhesive layer thickness at 2 m/sec. E-modulus testing is measured following DIN EN ISO 527-1 with a dumbbell specimen.

Table 6 shows the rheological properties of uncured adhesive formulation series A shortly after the formulations are prepared.

TABLE 6
Rheology test results for formulation series A

| | AA | AB | AC | AD | AE | AU | AV |
|---|---|---|---|---|---|---|---|
| Viscosity, Casson, 45° C. [Pas] | 323 | 327 | 507 | 439 | 430 | 152 | 299 |
| Viscosity at 10 s−1 [Pas] | 577 | 575 | 819 | 799 | 754 | 300 | 490 |
| Yield stress, Casson, 45° C. [Pa] | 375 | 357 | 371 | 461 | 340 | 245 | 231 |

Storage data at various temperatures are generated for uncured formulation AA, AU and AV, over a time frame of 1 to 4 weeks, and provided in Tables 7 and 8. Mechanical strength and adhesive bulk data for some series A adhesives are given in Table 9.

TABLE 7
Storage Properties for formulation AA

| | 40° C. | 50° C. | 60° C. |
|---|---|---|---|
| 1 week (calculated viscosity Casson) | 383 | 403 | 481 |
| Factor increase | 1.2 | 1.3 | 1.5 |
| Difference | 60 | 80 | 158 |
| 1 week (viscosity at 10 s−1) | 704 | 688 | 756 |
| Factor increase | 1.2 | 1.2 | 1.3 |
| Difference | 127 | 111 | 179 |
| 2 weeks (calculated viscosity Casson) | 417 | 434 | 620 |
| Factor increase | 1.3 | 1.3 | 1.9 |
| Difference | 94 | 111 | 297 |
| 2 weeks (viscosity at 10 s−1) | 708 | 701 | 854 |
| Factor increase | 1.2 | 1.2 | 1.5 |
| Difference | 131 | 124 | 277 |
| 3 weeks (calculated viscosity Casson) | 422 | 464 | 799 |
| Factor increase | 1.3 | 1.4 | 2.5 |
| Difference | 99 | 141 | 476 |
| 3 weeks (viscosity at 10 s−1) | 738 | 742 | 1196 |
| Factor increase | 1.3 | 1.3 | 2.1 |
| Difference | 161 | 165 | 619 |
| 4 weeks (calculated viscosity Casson) | 428 | 512 | 1912 |
| Factor increase | 1.3 | 1.6 | 5.9 |
| Difference | 105 | 189 | 1589 |
| 4 weeks (viscosity at 10 s−1) | 729 | 819 | 2219 |
| Factor increase | 1.3 | 1.4 | 3.8 |
| Difference | 152 | 242 | 1642 |

TABLE 8
Storage Properties for formulations AU and AV

| | AU | | AV | |
|---|---|---|---|---|
| | 50° C. | 60° C. | 50° C. | 60° C. |
| 1 week (calculated viscosity | 168 | 176 | 323 | 357 |
| Casson) | | | | |
| Factor increase | 1.1 | 1.2 | 1.1 | 1.2 |
| Difference | 16 | 24 | 24 | 58 |
| 1 week (viscosity at 10 s−1) | 307 | 317 | 510 | 550 |
| Factor increase | 1.0 | 1.1 | 1.0 | 1.1 |
| Difference | 7 | 17 | 25 | 60 |
| 2 weeks (calculated viscosity | 172 | 206 | 363 | 365 |
| Casson) | | | | |
| Factor increase | 1.1 | 1.4 | 1.2 | 1.2 |
| Difference | 20 | 54 | 64 | 66 |
| 2 week (viscosity at 10 s−1) | 308 | 355 | 564 | 561 |
| Factor increase | 1.0 | 1.2 | 1.2 | 1.1 |
| Difference | 8 | 55 | 74 | 71 |
| 4 weeks (calculated viscosity | 186 | — | 350 | — |
| Casson) | | | | |
| Factor increase | 1.2 | — | 1.2 | — |
| Difference | 34 | — | 51 | — |
| 4 week (viscosity at 10 s−1) | 323 | — | 533 | — |
| Factor increase | 1.1 | — | 1.1 | — |
| Difference | 23 | — | 43 | — |

TABLE 9
Mechanical properties for formulation series A (cured)

| | AA | AB | AC | AD | AE | AU | AV |
|---|---|---|---|---|---|---|---|
| Impact peel strength at RT | 32 | 34 | 28 | 17 | 30 | 31 | 28 |
| [N/mm] | | | | | | | |
| Impact peel strength at −40° C. | 23 | 24 | 9 | 0 | 24 | | |
| [N/mm] | | | | | | | |
| Lap shear strength [MPa] | 19 | 19 | 20 | 19 | 17 | | |
| E-Modulus [MPa] | 1940 | 1780 | 2284 | 2717 | 1480 | 2092 | 1992 |
| Tensile Strength [MPa] | 36.7 | 38.7 | 46.6 | 54.9 | 33 | 37 | 34 |
| Elongation [%] | 6.5 | 7.4 | 6.2 | 5.8 | 11.7 | 4.9 | 6.1 |
| Tg, DSC [° C.] | 108 | 103 | 100 | 93 | 112 | | |

Table 10 shows the rheological properties of uncured adhesive formulation series B shortly after the formulations are prepared.

TABLE 10
Initial rheological properties for formulation series B

| | BF | BG | BH | BI | BJ | BT |
|---|---|---|---|---|---|---|
| Viscosity, Casson, 45° C. | 221 | 286 | 229 | 529 | 302 | 180 |
| [Pas] | | | | | | |
| Viscosity at 10 s−1 [Pas] | 455 | 580 | 519 | 958 | 573 | 308 |
| Yield stress, Casson, 45° C. | 358 | 438 | 528 | 505 | 331 | 163 |
| [Pa] | | | | | | |

Storage data at various temperatures are generated for uncured formulation BF and BT over a time frame of 1 to 4 weeks, and provided in Tables 11 and 12. Mechanical strength and adhesive bulk data for some series B adhesives are given in Table 13.

TABLE 11
Storage Properties for formulation BF

| | 30° C. | 40° C. | 50° C. | 60° C. |
|---|---|---|---|---|
| 1 week (calculated viscosity | 247 | 291 | 311 | 360 |
| Casson) | | | | |
| Factor increase | 1.1 | 1.3 | 1.4 | 1.6 |
| Difference | 26 | 70 | 90 | 139 |
| 1 week (viscosity at 10 s−1) | 465 | 524 | 593 | 638 |
| Factor increase | 1 | 1.2 | 1.3 | 1.4 |
| Difference | 10 | 69 | 138 | 183 |
| 2 weeks (calculated viscosity | 257 | 293 | 358 | 592 |
| Casson) | | | | |
| Factor increase | 1.2 | 1.3 | 1.6 | 2.7 |
| Difference | 36 | 72 | 137 | 371 |
| 2 weeks (viscosity at 10 s−1) | 496 | 540 | 651 | 1036 |
| Factor increase | 1.1 | 1.2 | 1.4 | 2.3 |
| Difference | 41 | 85 | 196 | 581 |
| 3 weeks (calculated viscosity | 273 | 306 | 412 | 999 |
| Casson) | | | | |
| Factor increase | 1.2 | 1.4 | 1.9 | 4.5 |
| Difference | 52 | 85 | 191 | 778 |
| 3 weeks (viscosity at 10 s−1) | 516 | 580 | 693 | 1466 |
| Factor increase | 1.1 | 1.3 | 1.5 | 3.2 |
| Difference | 61 | 125 | 1.5 | 1011 |
| 4 weeks (calculated viscosity | 281 | 317 | 457 | 1773 |
| Casson) | | | | |
| Factor increase | 1.3 | 1.4 | 2.1 | 8 |
| Difference | 60 | 96 | 236 | 1552 |
| 4 weeks (viscosity at 10 s−1) | 493 | 611 | 785 | 2137 |
| Factor increase | 1.1 | 1.3 | 1.7 | 4.7 |
| Difference | 38 | 156 | 330 | 1682 |

TABLE 12
Storage Properties for formulation BT

| | 50° C. | 60° C. |
|---|---|---|
| 1 week (calculated viscosity Casson) | 233 | 286 |
| Factor increase | 1.3 | 1.6 |
| Difference | 53 | 106 |
| 1 week (viscosity at 10 s−1) | 360 | 554 |
| Factor increase | 1.2 | 1.8 |
| Difference | 52 | 246 |
| 2 weeks (calculated viscosity Casson) | 177 | 187 |
| Factor increase | 1.0 | 1.0 |
| Difference | −3 | 7 |
| 2 week (viscosity at 10 s−1) | 319 | 332 |
| Factor increase | 1.0 | 1.1 |
| Difference | 11 | 24 |
| 4 weeks (calculated viscosity Casson) | 277 | 369 |
| Factor increase | 1.5 | 2.1 |
| Difference | 97 | 189 |
| 4 week (viscosity at 10 s−1) | 478 | 566 |
| Factor increase | 1.6 | 1.8 |
| Difference | 170 | 258 |

TABLE 13
Mechanical properties for formulation series B (cured)

| | BF | BG | BH | BI | BJ | BT |
|---|---|---|---|---|---|---|
| Impact peel strength at RT [N/mm] | 29 | 26 | 22 | 12 | 26 | 27 |
| Impact peel strength at −40° C. [N/mm] | 17 | 18 | 1 | 1 | 20 | |
| Lap shear strength [MPa] | 19 | 19 | 19 | 18 | 18 | |
| E-Modulus [MPa] | 2296 | 2446 | 2670 | 3220 | 1773 | 2389 |
| Tensile Strength [MPa] | 45 | 46 | 54 | 59 | 36 | 38 |
| Elongation [%] | 6.8 | 5.3 | 6.6 | 4.0 | 8.0 | 4.6 |
| Tg, DSC [° C.] | 98 | 90 | 91 | 92 | 106 | |

The storage data of inventive formulations AA-AE and BF-BJ, can be compared to reference adhesive formulations summarized in the Tables below. In particular, in similar manner, the initial rheological properties, and rheological properties over time, are provided in Tables 14-16 for the comparative adhesive formulations. Mechanical properties of the cured comparative formulations are provided in Table 17.

TABLE 14
Initial rheological properties for comparative formulations

| | RQ | RR | RS |
|---|---|---|---|
| Viscosity, Casson, 45° C. [Pas] | 73 | 102 | 39 |
| Viscosity at 10 s−1 [Pas] | 219 | 247 | 817 |
| Yield stress, Casson, 45° C. [Pa] | 367 | 301 | 430 |

TABLE 15
Storage Properties for formulation RQ

| | 30° C. | 40° C. | 50° C. | 60° C. |
|---|---|---|---|---|
| 1 week (calculated viscosity | 104 | 160 | 226 | 416 |
| Casson) | | | | |
| Factor increase | 1.4 | 2.2 | 3.1 | 5.7 |
| Difference | 31 | 87 | 153 | 343 |
| 1 week (viscosity at 10 s−1) | 244 | 313 | 433 | 690 |
| Factor increase | 1.1 | 1.4 | 2 | 3.2 |
| Difference | 25 | 94 | 214 | 471 |
| 2 weeks (calculated viscosity | 153 | 203 | 358 | 1977 |
| Casson) | | | | |
| Factor increase | 2.1 | 2.8 | 4.9 | 27 |
| Difference | 80 | 130 | 285 | 1904 |
| 2 weeks (viscosity at 10 s−1) | 303 | 377 | 617 | 2305 |
| Factor increase | 1.4 | 1.7 | 2.8 | 10.5 |
| Difference | 84 | 158 | 398 | 2086 |
| 3 weeks (calculated viscosity | 168 | 257 | 640 | Gelled |
| Casson) | | | | |
| Factor increase | 2.3 | 3.5 | 567 | |
| Difference | 94 | 184 | 8.8 | |
| 3 weeks (viscosity at 10 s−1) | 342 | 447 | 995 | Gelled |
| Factor increase | 1.6 | 2.0 | 4.5 | |
| Difference | 123 | 228 | 776 | |
| 4 weeks (calculated viscosity | 179 | 332 | 1236 | Gelled |
| Casson) | | | | |
| Factor increase | 2.5 | 4.5 | 1163 | |
| Difference | 106 | 259 | 17.3 | |
| 4 weeks (viscosity at 10 s−1) | 324 | 524 | 1581 | Gelled |
| Factor increase | 1.5 | 2.4 | 7.2 | |
| Difference | 105 | 305 | 1362 | |

TABLE 16
Storage Properties for formulation RR

| | 30° C. | 40° C. | 50° C. | 60° C. |
|---|---|---|---|---|
| 1 week (calculated viscosity | 166 | 307 | 535 | 1281 |
| Casson) | | | | |
| Factor increase | 1.6 | 3 | 5.2 | 12.6 |
| Difference | 64 | 205 | 433 | 1179 |
| 1 week (viscosity at 10 s−1) | 322 | 509 | 782 | 3818 |
| Factor increase | 1.3 | 2.1 | 3.2 | 15.5 |
| Difference | 75 | 262 | 535 | 3571 |
| 2 weeks (calculated viscosity | 277 | 434 | 872 | 6941 |
| Casson) | | | | |
| Factor increase | 2.7 | 4.3 | 8.5 | 68 |
| Difference | 175 | 332 | 770 | 6839 |
| 2 weeks (viscosity at 10 s−1) | 466 | 696 | 1372 | 10289 |
| Factor increase | 1.9 | 2.8 | 5.6 | 41.7 |
| Difference | 219 | 449 | 1125 | 10042 |
| 3 weeks (calculated viscosity | 324 | 598 | 1619 | Gelled |
| Casson) | | | | |
| Factor increase | 3.2 | 5.7 | 15.9 | |
| Difference | 222 | 496 | 1517 | |
| 3 weeks (viscosity at 10 s−1) | 539 | 858 | 2013 | Gelled |
| Factor increase | 2.2 | 3.5 | 8.1 | |
| Difference | 292 | 611 | 1766 | |
| 4 weeks (calculated viscosity | 374 | 841 | 4411 | Gelled |
| Casson) | | | | |
| Factor increase | 3.7 | 8.2 | 43.2 | |
| Difference | 272 | 739 | 4309 | |
| 4 weeks (viscosity at 10 s−1) | 552 | 1193 | too high, | Gelled |
| | | | no value | |
| Factor increase | 2.2 | 4.8 | | |
| Difference | 305 | 946 | | |

TABLE 17
Mechanical properties for comparative formulations (cured)

| | RQ | RR | RS |
|---|---|---|---|
| Impact peel strength at RT [N/mm] | 34 | 30 | 38 |
| Impact peel strength at −40° C. [N/mm] | 18 | 22 | 21 |
| Lap shear strength [MPa] | 19 | 24 | 20 |
| E-Modulus [MPa] | 2305 | 2152 | 1844 |
| Tensile Strength [MPa] | 42 | 37 | 33 |
| Elongation [%] | 5.0 | 3.8 | 4.1 |
| Tg, DSC [° C.] | 93 | 99 | 94 |

The mechanical quasi-static lap shear strength values are very similar and almost independent of the toughener formulation (exception for formulation RR which uses comparative toughener R).

The impact peel strength values at 23° C. test temperature appears to depend on the molecular weight of the toughener composition. The lower the molecular weight of the used PTHF (PTMEG), the lower the value, which is even more pronounced at −40° C. test temperature. Comparative formulation RQ, shows a slightly higher 23° C. impact peel strength value.

The adhesive viscosity of the inventive formulations are higher compared to the comparative formulations which is possibly due to the higher molecular weight of the inventive toughener. The adhesive viscosity can be adjusted to lower values by simply modifying the adhesive formulation and using less of the liquid/solid epoxy resin blend in favor of more liquid epoxy resin.

The increase of the Casson viscosity, as well as the real viscosity at a given shear rate, of the inventive formulations with temperature and time is significantly lower compared to the comparative formulations. It is already very significant at test temperatures of 40° C. and becomes very pronounced at temperature of 50° C. and above.

The E-modulus of the inventive adhesive formulations that use IPDI for the toughener composition (B-series) is generally higher than for adhesive formulations which are using HDI for the toughener composition (A-series).

The molecular weights of the inventive toughener formulations that use IPDI for the toughener composition (B-series) is lower than for toughener formulations which are using HDI for the toughener composition (A-series).

The concept of improving the stability by reacting the toughener with epoxy resin appears to be valid independently of the toughener composition. As noted above, any synthesis method may be used, e.g., concurrent or sequential. The invention includes a toughener that can be structurally viewed as an isocyanate-terminated PU prepolymer linked to an epoxy via a polyphenolic group or an at least di-hydroxy-functional benzene (two or more hydroxy groups).

The inventive adhesive formulations of series A and B show significant improvement in the adhesive bulk stability over the reference formulations. The mechanical strength values are comparable and on high levels.

In the Examples, it is observed that the molecular weight of polyTHF has an effect on performance of the inventive toughener. A molecular weight of polyTHF above 1400 Da is preferred for improved impact peel strength values at 23° C., since impact peel strength decreases when the PolyTHF has a molecular weight of 1400 Da and below.

A molecular weight of the polyTHF of above 1700 Da is more preferred since impact peel strength values at −40° C. test temperature are lower when the polyTHF has a molecular weight of 1700 Da and below.

IPDI is preferred over HDI for the toughener composition, since it appears to confer a higher modulus to the adhesive formulation.

1. A reaction product of:
a) a first reaction product of an isocyanate terminated prepolymer, and a capping compound having a di-functional aromatic moiety, wherein the first reaction product is terminated with the capping compound;
and
b) a diglycidyl bisphenol epoxy resin;
wherein the reaction product is suitable for use as a toughener in an epoxy adhesive composition.

2. The reaction product of claim 1, wherein component a) comprises a reaction product of a polyether diol and an isocyanate.

3. The reaction product of claim 2, wherein the polyether diol comprises a PTMEG-based polymer and/or a polybutadienediol-based polymer and the isocyanate comprises an aliphatic isocyanate.

4. The reaction product of claim 2, wherein the aliphatic isocyanate comprises HDI and/or IPDI.

5. The reaction product of claim 1, wherein the first reaction product comprises free hydroxy groups from the one or more capping compounds, and substantially all of the free hydroxy groups are reacted with the diglycidyl bisphenol epoxy resin.

6. The reaction product of claim 1, wherein the one or more capping compounds comprises at least one of o,o′-diallyl bisphenol A and bisphenol A.

7. The reaction product of claim 1, wherein the isocyanate terminated prepolymer comprises a polyurethane prepolymer.

8. The reaction product of claim 1, wherein the diglycidyl bisphenol epoxy resin comprises a liquid diglycidyl bisphenol A epoxy resin.

9. The reaction product of claim 1 having Mn in the range of 3,000 to 12,000 Da.

10. The reaction product of claim 1 having Mw in the range of 4,000 to 20,000 Da.

11. A reaction product of:
a) an isocyanate terminated prepolymer;
b) a polyphenol or a dihydroxy functional benzene compound or a derivative thereof; and
c) a diglycidyl bisphenol epoxy resin;
wherein the reaction product is suitable for use as a toughener in an epoxy adhesive composition.

12. The reaction product of claim 11, wherein b) comprises a bisphenol or a derivative thereof.

13. The reaction product of claim 11, wherein b) comprises resorcinol and/or a substituted resorcinol.

14. An adhesive composition comprising:
i) a diglycidyl ether bisphenol epoxy resin;
ii) a toughener comprising the reaction product of claim 1;
iii) a hardener; and
iv) a curing accelerator.

15. The adhesive composition of claim 14 comprising:
i) 20 to 60 wt % of the diglycidyl ether bisphenol epoxy resin;
ii) 15 to 60 wt % of the toughener;
iii) 1 to 8% of the hardener; and
iv) 0.1 to 3 wt % of the curing accelerator;
wherein the weight percents are based on the weight of the composition.

16. A cured adhesive obtained by curing the adhesive composition of claim 14.

17. A composition suitable for use as a toughener in an epoxy adhesive composition, the composition comprising an epoxy terminated polyurethane coupled via a polyphenolic blocking agent.
